(19) United States
(12) Patent Application Publication
(10) Pub. No.: US 2006/0011002 A1
(43) Pub. Date: Jan. 19, 2006

(54) Machine tool with dimensional change compensation

(76) Inventor: Timothy L. Rashleger, Minnetrista, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/179,105

(22) Filed: Jul. 12, 2005

Related U.S. Application Data
(60) Provisional application No. 60/587,357, filed on Jul. 13, 2004.

(51) Int. Cl. F16H 25/20

(52) U.S. Cl. 74/89.23

(57) ABSTRACT

A machine tool including a system for adjusting the position of a portion of the tool based on thermally induced dimensional change. A linear voltage to distance transducer (LVDT), or a hall effect linear transducer, is mounted at the “floating” end of the ball screw or other machine component of the machine tool to directly sense the thermal expansion of the screw or component. The LVDT includes a slug portion which is received in a coil. The slug is affixed to the floating end of the screw or component and the coil is affixed to the bearing block in which the screw or component is rotatably supported. Thermal expansion of the screw or component causes the slug to move axially within the coil, in turn causing the coil to produce an electrical signal with a varying voltage proportional to the change in position of the slug within the coil.

### RELATED APPLICATIONS

This application claims the benefit of U.S. Provisional Application No. 60/587,357, filed Jul. 13, 2004, hereby fully incorporated herein by reference.

### FIELD OF THE INVENTION

The present invention relates to machine tools, and more specifically to computer controlled machine tools with dimensional change compensation.

### BACKGROUND OF THE INVENTION

Precision machine tools, such as CNC tools, are widely used in industry to make machine parts and components. The degree of machining accuracy required for these machine parts and components is often high, requiring that the moving parts of the machine tool, especially those for positioning a tool relative to a workpiece, be capable of extremely precise, predictable, and repeatable movement. Such a CNC machine tool is disclosed in U.S. Pat. No. 6,325,697, hereby fully incorporated herein by reference.

One assembly commonly used in machine tools for positioning a tool is known as a ball screw assembly. Generally, the ball screw assembly includes an elongate screw rotatably mounted in a pair of spaced apart bearings. A machine slide, to which the tool is coupled, is engaged with a ball screw nut on the screw and moves axially along the screw upon rotation of the screw. The direction of travel of the machine slide depends on the direction of rotation of the screw. The screw or the servo motor driving the screw typically has a rotary position device (rotary counter) which positions the screw to a specific point of rotation. By rotating the screw to a specific point of rotation positions, the slide driven by the ball screw nut to position to a precise linear position. One of the bearings is generally a thrust bearing, which locates the screw relative to a machine axis and restricts axial movement of the screw, while the other bearing enables the end of the screw to “float” axially to account for thermal expansion of the screw.

Thermal expansion of components of the screw and other components of the ball screw assembly may affect the position of the machine slide and tool. Rotation of the screw in the bearings and the movement of the ball screw nut on the screw create friction, resulting in heat transfer to the screw, and a consequent change in length of the screw due to thermal expansion or contraction with the temperature change. Heat can also be introduced to the screw from friction in other parts of the ball screw assembly, such as motors, drive pulleys, belts, and gears, as well as from the spindle of the tool. Unless compensated, thermal expansion of the screw will cause the rotary position device, which tracks only rotary position of the screw, to inaccurately position the slide.

Previous approaches have compensated for thermal expansion of the screw by sensing the temperature of the ball screw nut and making assumptions as to what temperature the ball screw is to calculate the change in length of the screw using the thermal expansion coefficient of the screw material. This calculated screw length is then used as an input to adjust the position of the machine slide and tool.

A disadvantage of this approach is the ball screw nut temperature may not represent the temperature of the ball screw over its full length. Bearings supporting the ball screw can produce heat into the ball screw that does not get transferred to the ball screw nut. If the travel of the ball screw nut only occurs over a small area of the ball screw, again the ball screw nut temperature will not reflect the temperature along the entire length of the ball screw. As a result, compensation approaches in which the ball screw nut temperature is relied on are typically inaccurate. These methods have prevailed because the ball screw nut does not rotate and the thermal measurement device can be mounted to it easily.

Another previous method uses a linear positioning counter connected to the slide itself which forces the machine tool computer to an exact point (count) of the linear scale. This approach, however, may add undesirable complexity and additional cost to the machine tool.

What is needed in the industry is a low-cost device and method for directly compensating for thermal expansion of a machine tool component such as a ball screw.

### SUMMARY OF THE INVENTION

The present invention addresses the need of the industry by providing a low-cost system and method for directly compensating for thermal expansion of a machine tool component such as a ball screw. Two styles can be applied which both offer direct measurement of growth rather than the measurement of temperature and consequential estimates of thermal expansion. According to an embodiment of the invention, a linear voltage to distance transducer (LVDT), or a hall effect linear transducer, is mounted at the “floating” end of the ball screw to directly sense the thermal expansion of the screw. The LVDT includes a slug portion which travels within a coil. The slug is affixed to the floating end of the screw and the coil is affixed to the bearing block in which the screw is rotatably mounted. Thermal expansion of the screw causes the slug to move axially within the coil, in turn causing the coil to produce an electrical signal with a varying voltage proportional to the change in position of the slug within the coil.

In an alternative embodiment, a magnetic Hall effect linear transducer system includes a magnet affixed to the floating end of the screw and a Hall effect linear transducer affixed to the bearing block in which the screw is rotatably mounted. Thermal expansion of the screw causes the magnet to move axially toward or away from the Hall effect linear transducer in turn causing the Hall effect transducer to produce an electrical signal with a varying voltage proportional to the change of distance between the magnet mounted on the end of the ball screw and the Hall effect linear transducer pick-up device. The signals from the coil or the Hall effect transducer may be digitized and provided as an input to the computer controlling the machine tool. The machine tool computer may use this input to accurately determine the position of the tool accounting for the thermal expansion of the screw or other components in the ball screw assembly.

In an embodiment of the invention, a machine tool includes a pair of spaced apart support structures and an elongate element having a pair of opposing ends and presenting a length dimension. The element extends between the support structures and is selectively rotatably mounted thereby so that one of the pair of opposing ends of the element is constrained from longitudinal movement relative to the support structures and the other of the opposing ends is free to move longitudinally relative to the support structures in response to changes in the length dimension of the element. The system further includes a length change sensing apparatus with a first portion of the apparatus fixedly coupled with the support structure proximate the free end of the element, and a second portion of the apparatus operably coupled to the free end of the elongate element so as to move relative to the first portion of the apparatus with changes in the length dimension of the element. The apparatus produces a signal having a parameter that varies linearly with changes in the length dimension of the element. This signal may be coupled to the computer control of the machine tool, where can be used to adjust the position of a tool positioned along the length of the element for the thermal growth of the element.

### BRIEF DESCRIPTION OF THE DRAWINGS

FIG. 1 is a fragmentary exploded view of a ball screw assembly of a machine tool according to an embodiment of the present invention;

FIG. 2 is an axial cross-sectional view of the ball screw assembly and LVDT temperature compensation apparatus depicted in FIG. 1; and

FIG. 3 is a fragmentary exploded view of a ball screw assembly of a machine tool according to an alternative embodiment of the present invention.

### DETAILED DESCRIPTION OF THE PREFERRED EMBODIMENTS

Ball screw assembly 10 of a machine tool (not depicted) generally includes screw 12 which is rotatably mounted in thrust bearing 14 and bearing 16, which is received in bearing block 17. Thrust bearing 14 axially locates screw 12 at distal end 18, while proximal end 20 of screw 12 “floats” axially in bearing 16. A ball screw nut (not depicted) is threadably received on screw 12, and moves axially along screw 12 as screw 12 rotates in order to drive a linear slide for positioning a tool (not depicted).

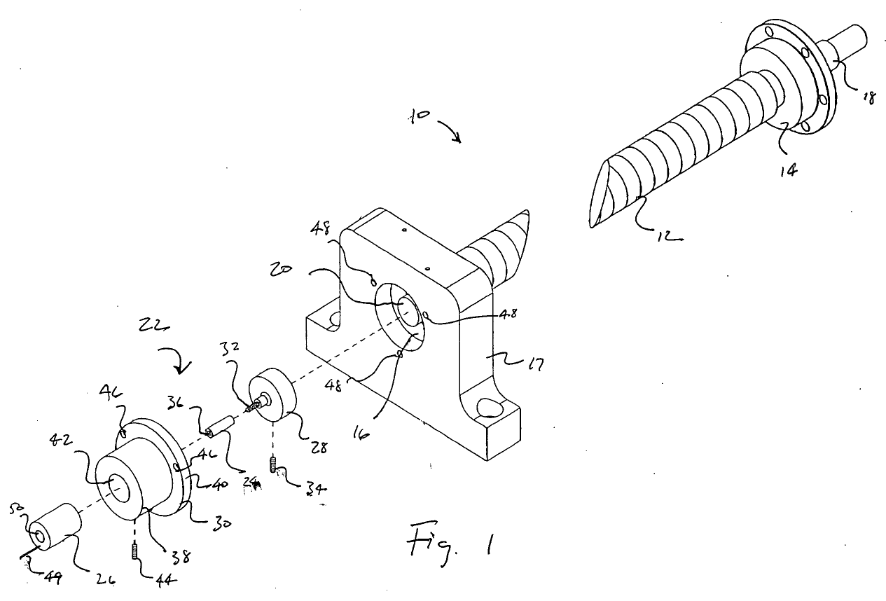

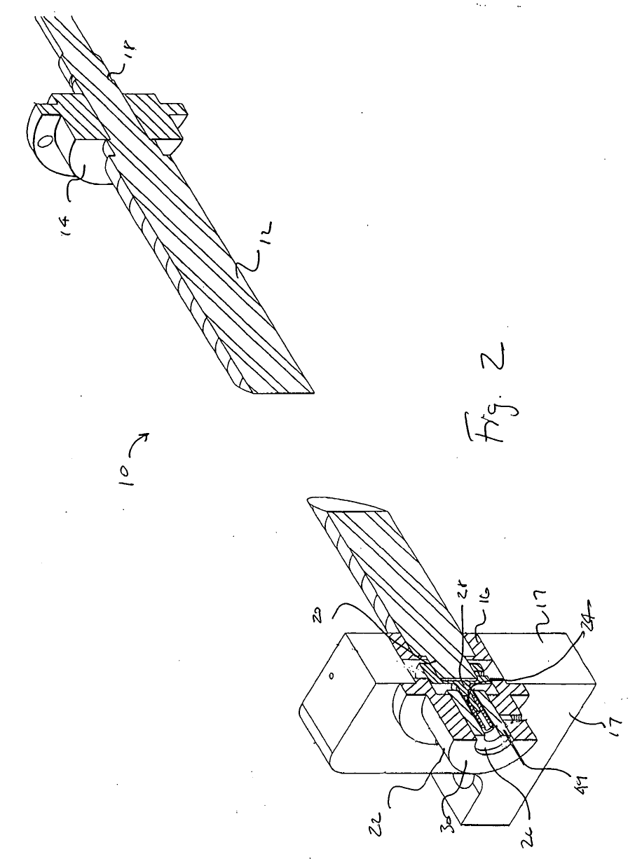

In the embodiment of FIGS. 1 and 2, measuring temperature compensation apparatus 22 generally includes LVDT slug 24, LVDT coil 26, slug mount 28, and coil mount 30. Slug mount 28 has an axially projecting threaded portion 32 and is fixed on proximal end 20 of screw 12 with set screw 34. LVDT slug 24 defines axial bore 36, which is internally threaded and dimensioned so that LVDT slug 24 may be threaded onto threaded portion 32 of slug mount 28.

Coil mount 30 generally includes cylindrical body portion 38 and flange portion 40. Cylindrical body portion 38 defines bore 42 for receiving LVDT coil 26 therein. LVDT coil 26 is fixed within bore 42 with set screw 44. Flange portion 40 of coil mount 30 may have a plurality of apertures 46 defined therein, corresponding to apertures 48 in bearing block 17. Fasteners (not depicted) extending through apertures 46 and into apertures 48 may be used to secure coil mount 30 to bearing block 17. LVDT coil 26 is coupled to the machine tool computer control (not depicted) through one or more wires 49.

LVDT slug 24 travels within axial bore 50 of LVDT coil 26. As screw 12 rotates, LVDT slug 24, which is fixed to screw 12 with slug mount 28, rotates within axial bore 50 of LVDT coil 26, which is fixed to bearing block 17. Further, as the axial length of screw 12 changes with temperature, LVDT slug 24 travels axially within axial bore 50. As the axial position of LVDT slug 24 changes within LVDT coil 26, the output voltage of LVDT coil 26 changes in linear proportion to the distance LVDT slug 24 moves.

LVDT slug 24 and LVDT coil 26 may be selected from commercially available LVDT components. It will be appreciated that slug mount 28 and coil mount 30 may be fashioned from any suitable material, such as for example, metals including cast iron or steel.

It will be appreciated by those of skill in the art that the output voltage of LVDT coil 26 may be calibrated to represent a specific distance increment that LVDT slug 24 moves. For example, LVDT coil 26 may be calibrated to produce a 0.05 volt output voltage change for each 0.001 inch axial movement of LVDT slug 24 within axial bore 50. This voltage change signal from LVDT coil 26, which is representative of the overall length change of screw 12 due to thermal expansion, may be provided to the control computer of a CNC machine tool. The control computer may be programmed to apportion the overall thermal change distance equally over the length of screw 26. The control computer may then determine the appropriate modification for the position of the linear slide by adding or subtracting the appropriate portion of the thermal change distance depending on the axial position of the linear slide relative to the length of screw 12. Those of skill in the art will appreciate that this position correction algorithm for the axial slide may be implemented in the position loop of the CNC control computer. Essentially the computer that drives the position servo loop (servo motor) has a plus or minus correction to the position loop over many points based on the magnitude of the growth or shrinkage of the length of screw 12, which is represented by the travel of LVDT slug 24.

A specific operational example may serve to illustrate the operation of the present invention. During operation of a machine tool, ball screw 12, which has a 10 inch overall initial length, may absorb heat from friction, causing it to lengthen by 0.01 inch overall. LVDT slug 24 correspondingly moves axially 0.01 inch within axial bore 50 of LVDT coil 26. The axial movement of LVDT slug 24 causes a proportional variation in the output voltage of LVDT coil 26, which is communicated to the control computer of the machine tool. The control computer would calculate a 0.0001 inch position correction for each 0.1 inch of linear distance that linear slide is spaced apart from an index position on screw 12, which for convenience may be where it is axially located by thrust bearing 14. For instance, if the linear slide is positioned at a point one-half the length of screw 12, this position would be calculated as 5.005 inches from the index position at thrust bearing 14.

A further benefit of embodiments of the present invention is that the axial movement of screw 12 may be monitored as it changes from clockwise to counterclockwise rotation. Thrust bearing 14, which locates and inhibit axial movement of screw 12, will allow more and more axial movement as it wears. The control computer may be programmed to monitor the LVDT coil signal for a position change of LVDT slug 24 occurring at the instant screw 12 changes rotational direction. Any axial movement of screw 12 at the instant of direction change results in measurable change in LVDT coil output and gives a consequent quantifiable indication of thrust bearing wear or failure.

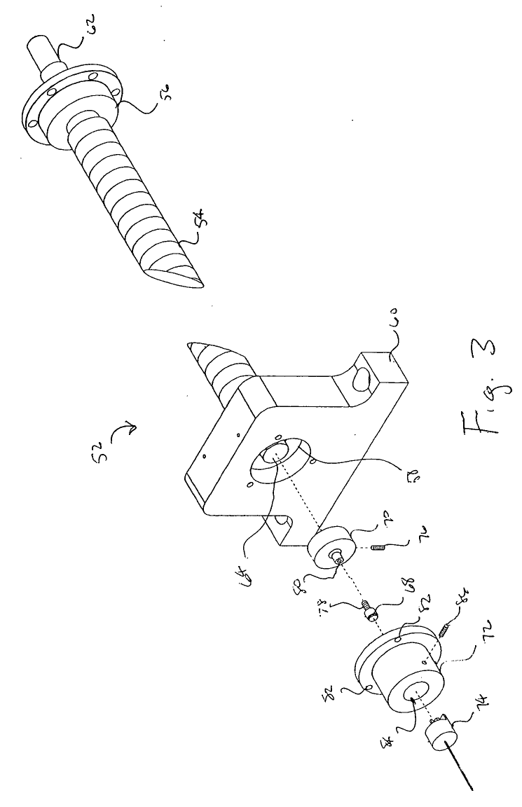

In the alternative embodiment of FIG. 3, ball screw assembly 52 of a machine tool (not depicted) generally includes screw 54 which is rotatably mounted in thrust bearing 56 and bearing 58, which is received in bearing block 60. Thrust bearing 56 axially locates screw 54 at distal end 62, while proximal end 64 of screw 54 “floats” axially in bearing 58. A ball screw nut (not depicted) is threadably received on screw 54, and moves axially along screw 54 as screw 54 rotates in order to drive a linear slide for positioning a tool (not depicted).

In the embodiment of FIG. 3, temperature compensation apparatus 66 generally includes magnet 68, magnetic mount 70, transducer mount 72, and Hall effect linear transducer 74. Magnetic mount 70 is received on proximal end 64 of screw 54 and is secured thereto with set screw 76. Magnet 68 has threaded portion 78, which is received in threaded bore 80 of magnetic mount 70. Transducer mount 72 is attached to bearing block 60 with fasteners (not depicted) through apertures 82. Transducer 74 is received in bore 84 of mount 72 and is secured in place with set screw 86.

In operation, a change in the length of screw 54 causes magnet 68 to move axially relative to transducer 74, resulting in an air gap change. This air gap change results in a linearly proportional change in the output voltage of transducer 74. Like LVDT coil 26, the output voltage of transducer 74 may be calibrated to indicate the magnitude of axial travel.

It will also be appreciated that the present invention may be applied to determine thermal expansion or contraction of machine tool assemblies other than the ball screw assembly. For example, the spindle assembly of a machine tool is typically rotatably mounted in a cast iron housing and this housing is subject to thermal growth or shrinkage. As the cast iron changes temperature, it alters the location of the spindle centerline, which may then introduce a position error in the workpiece. An elongated rod made from a material having a temperature expansion coefficient significantly different from the material of the head assembly, may be affixed to a stationary point on the head assembly that houses the spindle. The opposite end of the elongated rod is allowed to float axially. An LVDT slug or magnet is fixed to the floating end of the rod. The LVDT slug or magnet is axially slidable in an LVDT coil or hall effect transducer, which is attached to another fixed structure. A signal is produced, as described above, proportional to the dimensional change in the spindle due to temperature change, and this signal may be used by the control computer to adjust tool position for dimensional change of the workpiece.

What is claimed is:

1. A machine tool comprising:
a pair of spaced apart support structures;
an elongate element having a pair of opposing ends and presenting a length dimension, the element extending between the support structures and selectively rotatably mounted thereby so that one of the pair of opposing ends of the element is constrained from longitudinal movement relative to the support structures and the other of the opposing ends is free to move longitudinally relative to the support structures in response to changes in the length dimension of the element; and
a length change sensing apparatus, a first portion of the apparatus fixedly coupled with the support structure proximate the free end of the element, a second portion of the apparatus operably coupled to the free end of the elongate element so as to move relative to the first portion of the apparatus with changes in the length dimension of the element, wherein the apparatus produces a signal having a parameter that varies linearly with changes in the length dimension of the element.

2. The machine tool of claim 1, wherein the support structures each include a bearing and the elongate element comprises a ball screw.

3. The machine tool of claim 1, wherein the elongate element comprises a workpiece.

4. The machine tool of claim 1, wherein the signal parameter is voltage.

5. The machine tool of claim 1, wherein the apparatus comprises a linear voltage to distance transducer.

6. The machine tool of claim 5, wherein the first portion of the apparatus is a coil and the second portion of the apparatus is a slug.

7. The machine tool of claim 1, wherein the apparatus comprises a Hall effect transducer.

8. The machine tool of claim 7, wherein the first portion of the apparatus is a Hall effect sensor and the second portion of the apparatus is a magnet.

9. The machine tool of claim 1, further comprising a computer control for selectively positioning a tool along the length dimension of the element, wherein the apparatus is communicatively connected with the computer control, and wherein the computer control adjusts the position of the tool based on the signal provided by the apparatus.

10. A machine tool comprising:
a pair of spaced apart support structures;
an elongate element having a pair of opposing ends and presenting a length dimension, the element extending between the support structures and selectively rotatably mounted thereby so that one of the pair of opposing ends of the element is constrained from longitudinal movement relative to the support structures and the other of the opposing ends is free to move longitudinally relative to the support structures in response to changes in the length dimension of the element; and
means for producing a signal having a parameter that varies linearly with changes in the length dimension of the element.

11. The machine tool of claim 10, wherein the means for producing a signal includes a length change sensing apparatus, a first portion of the apparatus fixedly coupled with the support structure proximate the free end of the element, a second portion of the apparatus operably coupled to the free end of the elongate element so as to move relative to the first portion of the apparatus with changes in the length dimension of the element.

12. The machine tool of claim 11, wherein the elongate element comprises a ball screw.

13. The machine tool of claim 11, wherein the elongate element comprises a workpiece.

14. The machine tool of claim 11, wherein the signal parameter is voltage.

15. The machine tool of claim 11, wherein the apparatus comprises a linear voltage to distance transducer.

16. The machine tool of claim 11, wherein the first portion of the apparatus is a coil and the second portion of the apparatus is a slug.

17. The machine tool of claim 11, wherein the apparatus comprises a Hall effect transducer.

18. The machine tool of claim 17, wherein the first portion of the apparatus is a Hall effect sensor and the second portion of the apparatus is a magnet.

19. The machine tool of claim 11, further comprising a computer control for selectively positioning a tool along the length dimension of the element, wherein the apparatus is communicatively connected with the computer control, and wherein the computer control adjusts the position of the tool based on the signal provided by the apparatus.

20. A method of dimensional change compensation for a machine tool, the machine tool comprising a pair of spaced apart support structures and an elongate element having a pair of opposing ends and presenting a length dimension, the element extending between the support structures and selectively rotatably mounted thereby so that one of the pair of opposing ends of the element is constrained from longitudinal movement relative to the support structures and the other of the opposing ends is free to move longitudinally relative to the support structures in response to changes in the length dimension of the element, the machine tool further comprising a computer control and tool assembly, the tool assembly selectively positionable along the length dimension of the element with the computer control, the method comprising steps of:
providing a length change sensing apparatus having a first portion and a second portion wherein the apparatus produces a signal having a parameter linearly variable with movement of the first portion relative to the second portion;
fixedly coupling the first portion of the apparatus with the support structure proximate the free end of the element, and operably coupling the second portion of the apparatus to the free end of the elongate element so as to move relative to the first portion of the apparatus with changes in the length dimension of the element;
receiving with the computer control the signal produced by the apparatus; and
adjusting the position of the tool assembly with the computer control based on a magnitude of variation in the signal parameter.
